(19) United States
(12) Patent Application Publication
(10) Pub. No.: US 2018/0024243 A1
(43) Pub. Date: Jan. 25, 2018

(54) POLARIZATION BASED CODED APERTURE LASER DETECTION AND RANGING

(71) Applicant: Arete Associates, Northridge, CA (US)

(72) Inventor: Micah Boyd, Longmont, CO (US)

(21) Appl. No.: 15/186,863

(22) Filed: Jun. 20, 2016

Related U.S. Application Data
(60) Provisional application No. 62/181,409, filed on Jun. 18, 2015.

(51) Int. Cl. G01S 17/32

(52) U.S. Cl. CPC G01S 17/32

(57) ABSTRACT

Systems and method herein provide for laser detection and ranging (LADAR). In one embodiment, a LADAR system includes a transmitter operable to switch continuous wave (CW) laser light between the two or more polarizations based on a code, and to transmit the two or more polarizations of the CW laser light at a target. The LADAR system also includes a receiver operable to detect the two or more polarizations of the CW laser light reflected from the target. The LADAR system also includes a processor operable to determine a range of the target based on a time of flight of the switched polarizations of the CW laser light from the transmitter to the receiver according to the code.

### CROSS REFERENCE TO RELATED APPLICATIONS

This patent application is a non-provisional patent application claiming priority to, and thus the benefit of an earlier filing date from, U.S. Provisional Patent Application No. 62/181,409 (filed Jun. 18, 2015), the entire contents of which are hereby incorporated by reference.

### BACKGROUND

Laser Detection and Ranging, or “LADAR” (also referred to as lidar) is a method of propagating a pulse of laser light to an object and measuring the time it takes for the pulse to scatter and return from the object. Typically, a LADAR system comprises a laser that fires pulses of laser light at a surface. A sensor on the LADAR system measures the amount of time it takes for each pulse to bounce back. Since, light moves at a constant and known speed (˜3×10⁸ meters per second in air), the LADAR system can calculate the distance between itself and the target.

Conventional direct detection LADAR systems accumulate statistics with multiple laser pulses to determine the range to a target. Using a constant repetition rate, the time between pulses, however, cannot be less than the round-trip time of flight of the optical pulse to the target. Otherwise, the conventional LADAR system produces range ambiguity. This range ambiguity is the result of uncertainty in how many laser pulses are in the air at any given time. To avoid the range ambiguity, an upper limit is placed on the repetition rate of the laser and consequently the number of signal returns that can be averaged within some sensing time is limited.

### SUMMARY

LADAR systems and methods are presented herein. In one embodiment, a LADAR system includes a transmitter operable to switch continuous wave (CW) laser light between the two or more polarizations based on a code, and to transmit the two or more polarizations of the CW laser light at a target. The LADAR system also includes a receiver operable to detect the two or more polarizations of the CW laser light reflected from the target. The LADAR system also includes a processor operable to determine a range of the target based on a time of flight of the switched polarizations of the CW laser light from the transmitter to the receiver according to the code.

The various embodiments disclosed herein may be implemented in a variety of ways as a matter of design choice. For example, some embodiments herein are implemented in hardware whereas other embodiments may include processes that are operable to implement and/or operate the hardware. Other exemplary embodiments, including software and firmware, are described below.

### BRIEF DESCRIPTION OF THE FIGURES

Some embodiments of the present invention are now described, by way of example only, and with reference to the accompanying drawings. The same reference number represents the same element or the same type of element on all drawings.

FIGS. 1A and 1B are block diagrams of an exemplary CW LADAR system.

FIG. 2 is a flowchart illustrating an exemplary process of the CW LADAR system of FIG. 1.

FIG. 3 illustrates exemplary signaling diagrams of the polarizations of the CW LADAR system.

FIGS. 4-7 illustrate exemplary experimental results of a CW LADAR system.

FIG. 8 is a block diagram of another exemplary CW LADAR system.

FIGS. 9A and 9B illustrate one exemplary CAL code generation technique.

FIG. 10 is a block diagram of another exemplary CW LADAR system.

FIG. 11 is a block diagram of another exemplary CW LADAR system.

FIG. 12 is a block diagram of another exemplary CW LADAR system.

FIG. 13 is a block diagram of an exemplary computing system in which a computer readable medium provides instructions for performing methods herein.

### DETAILED DESCRIPTION OF THE FIGURES

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention and are to be construed as being without limitation to such specifically recited examples and conditions. As a result, the invention is not limited to the specific embodiments or examples described below.

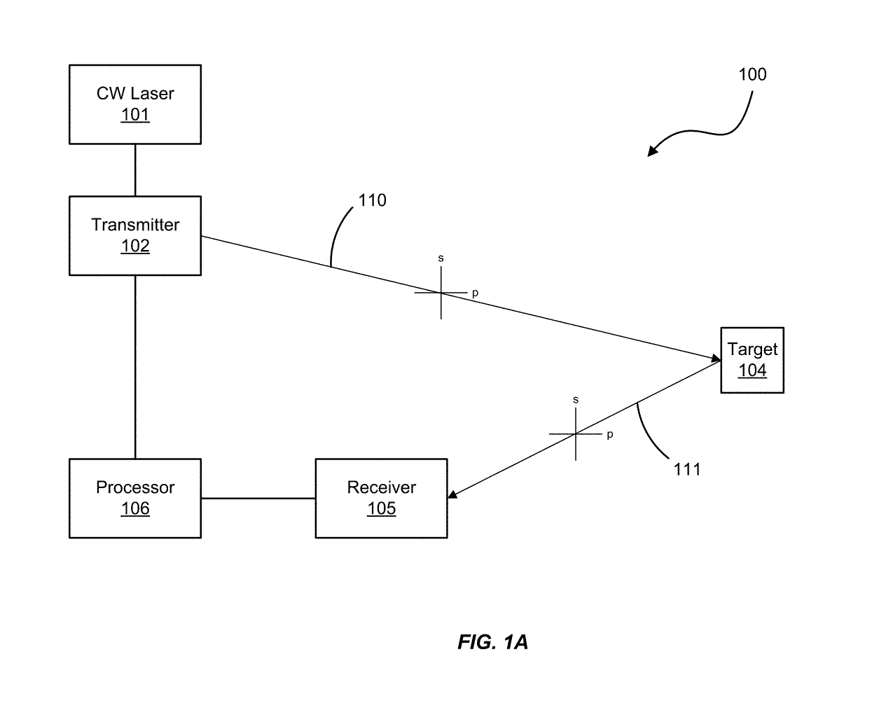

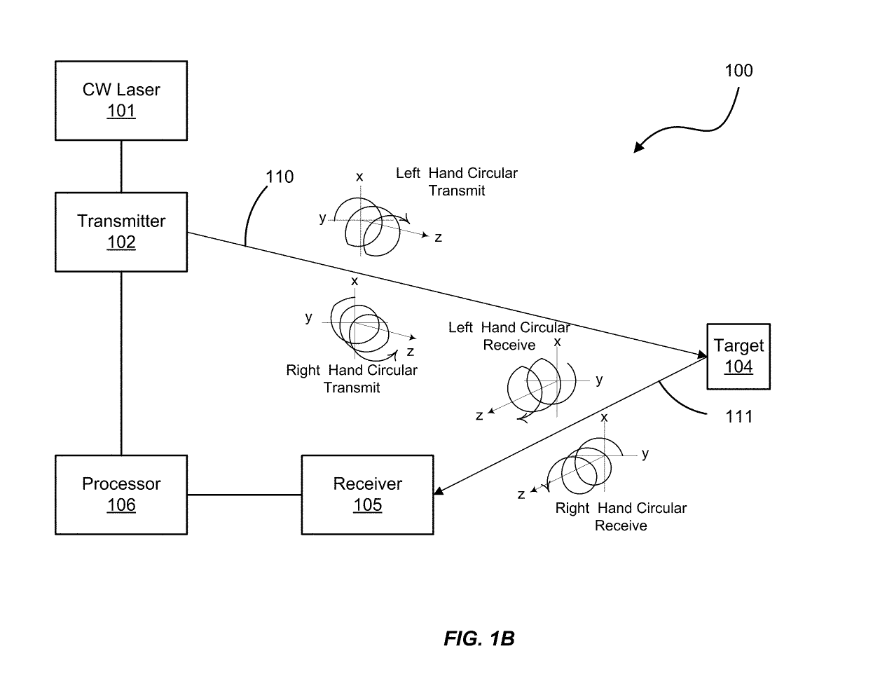

FIG. 1A is a block diagram of an exemplary CW LADAR system 100. The LADAR system 100 includes a CW laser 101 that is operable to generate CW laser light in at least two polarizations (e.g., represented in this embodiment as polarizations “s” and “p”). The LADAR system 100 also includes a transmitter 102 that is operable to propagate the laser light to a target 104. The transmitter 102 is also operable to switch the polarizations in a manner that is different from traditional LADAR pulses because the laser light continuously illuminates the target 104. For example, traditional LADAR systems pulse laser light on and off at a target and measure the time of flight of those pulses to and from the target to determine a range of the target. The transmitter 102 instead switches the polarizations of the laser light such that each switch of a polarization emulates pulses of the laser light. More specifically, the transmitter 102 modulates the switching between polarizations using a code (e.g., a pseudorandom code, a uniformly redundant sequence “URS” code, or the like). However, the laser light continuously transmits to the target 104 with no off time (i.e., until laser detection and ranging of the target is complete). The CW LADAR system 100 thereby provides a more covert form of LADAR detection and ranging as traditional LADAR detection systems (e.g., residing with the target 104) are configured for detecting discontinuous/discrete laser pulses. More specifically, the CW LADAR system 100 processes the code as opposed to laser pulses. As such, the CW LADAR system 100 may employ lower intensities of light, making the CW LADAR system 100 less likely to be observed by the target 104 or other observers, particularly in presence of background noise.

The LADAR system 100 also includes a receiver 105 that detects the reflections of the laser light with the switched polarization and a processor 106 that measures the time of flight of the polarization switching to determine the range to the target 104. For example, the processor 106 may measure a time of flight of the laser light in the s polarization and then measure the next time of flight of the laser light in the p polarization. Generally, this is performed through a correlation of the received coded sequence with the transmitted coded sequence.

To further illustrate with a simple example, assume that the transmitter 102 switches the polarizations of the CW laser light from the s polarization to the p polarization and back at a rate of 10 Hz. Thus, there will be five instances of the CW laser light in the s polarization transmitted to the target 104 per second and five instances of the CW light in the p polarization transmitted to the target 104 per second. While this example is not based on a coded sequence, each polarization may have a duration of approximately 100 ms while the beam 110 of the laser light continually illuminates the target 104. That is, the transmitter 102 may “paint” the target 104 in the s polarization for 100 ms, immediately followed by the p polarization for 100 ms, which is then immediately followed by the s polarization for 100 ms, and so on, while the beam 110 of the laser light continuously illuminates the target 104. Target 104 may include single reflected surfaces, multiple reflective surfaces at different ranges from the receiver, or distributed reflective elements (e.g. scatterers or particulates).

When the CW laser light illuminates the target 104, the light is reflected and scattered back to the receiver 105 (diffusely, specularly, or a combination thereof). The receiver 105 can detect the polarization switches reflected from the target 104 and the processor 106 measures the time of flight of these polarization switches. For example, the processor 106 measures the time of flight of the 100 ms duration of the CW laser light in the s polarization along the beam path 110 to the target 104 and its reflection from the target 104 along the path 111 to determine a distance to the target 104. The processor 106 then measures the time of flight of the next 100 ms duration of the CW laser light in the p polarization, and so on.

Now assume that the switching between polarizations is based on a 15 bit maximum length sequence (e.g., a pseudorandom code) of “111101011001000”, where the logical “1s” represent intensity in the s polarizations and the logical “0s” represent intensity in the p polarizations. The code is continuously transmitted at the target 104 via switched polarizations of the CW laser light, received by the receiver 105, and correlated with the transmitted code by the processor 106. Thus, the entire code is used to calculate the time of flight of the laser light from the transmitter 102 to the target 104 and back to the receiver 105. Since the code has roughly the same number of logical “1s” as it does logical “0s”, the sum of the s and p polarizations is essentially a constant intensity. And, as longer codes can be used, faster switching/modulation rates (e.g., in the MHz and GHz ranges) can be employed to improve range determinations through correlation.

It should be noted that the above example is merely intended for illustrative purposes and not intended to limit the invention. For example, the CW laser 101 may be implemented as any type of CW laser as a matter of design choice. Accordingly, the invention is not intended to be limited to any particular wavelength of laser light and/or power as such may be selected based on various environmental conditions (e.g., certain wavelengths of light may work better than others at penetrating moisture, such as clouds, fog, rain, etc., and other impurities).

Additionally, the maximum length sequence used in the example is merely intended to assist the reader in the LADAR ranging techniques of the CW LADAR system 100. Longer/faster codes can be and typically are used to assist in autocorrelation of the code to perform the LADAR ranging. For example, a Coded Aperture LADAR (CAL) code may be used as a signal sequence having more than five state switches. Such would have the effect of low side lobes after autocorrelation (e.g. codes that would produce side lobes with less than 10% of the peak). And, such a code may be a “cyclic CAL code” so as to provide a cyclic autocorrelation during ranging of the target 104. That is, a cyclic CAL code is a periodic code that, when a cyclic correlation is calculated with a rotated version of itself, a strong peak signal with low side-lobes is generated.

Moreover, while generally described with respect to the orthogonal polarizations “s” and “p”, the invention is not intended to be so limited. Other types of polarization may be modulated with a coded sequence for the LADAR ranging. For example, the laser of the transmitter 102 may be switched between left hand circular and right hand circular polarizations, as illustrated in FIG. 1B. In this regard, a coded sequence may be used to switch between the left hand and right hand circular polarizations when painting the target 104. Accordingly, the polarizations are not required to be geometrically normal (e.g., as with the orthogonal s and p polarizations) as they could be mathematically orthogonal (e.g., left-circular and right circular polarizations). And, the transmitter 102 may even use multiple lasers to perform the polarization switching. Other exemplary embodiments are shown and described below.

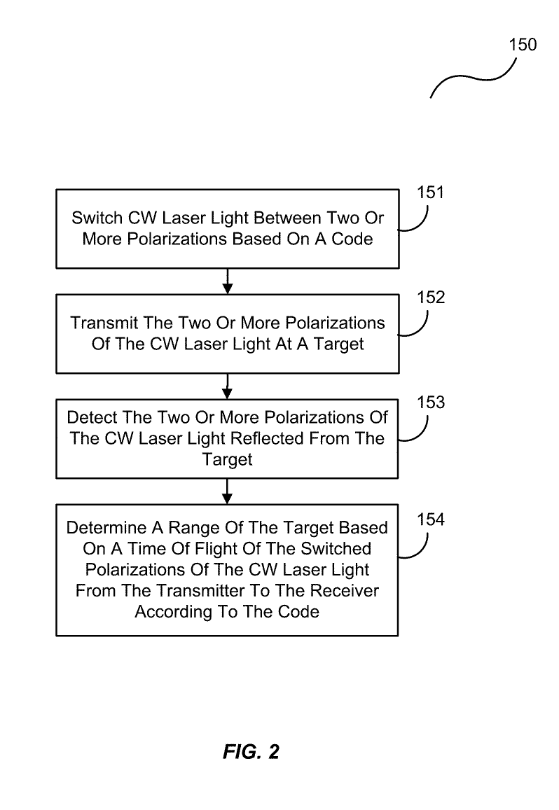

FIG. 2 is a flowchart illustrating an exemplary process 150 of the CW LADAR system 100 of FIG. 1. In this embodiment, CW laser light is switched between two or more polarizations, in the process element 151, based on a code sequence. That laser light is continuously transmitted in the two or more polarizations at the target 104 along the beam path 110, in the process element 102. The reflections off the target 104 along the path 111 are detected, in the process element 153, as well as its switched polarizations. From there, the processor 106 determines a range of the target 104 based on time of flight of the switched polarizations of the CW laser light from the transmitter 102 to the receiver 105 according to the code sequence, in the process element 154. For example, the processor 106 may correlate the received code sequence with the transmitted code sequence to determine the range to the target 104 based on the time of flight of the code sequence.

Generally, in this CAL system, the codes used to switch between the polarizations are selected from a set of numerical sequences that have autocorrelation properties without side-lobes (e.g., a delta-function response) or with suppressed side-lobes. Round trip ranges to the target 104 may then be determined by measuring the signal that reflects from the target 104 and correlating that signal in time with the known digital code sequence. The peak in an autocorrelation function can generally be located at the roundtrip time of flight, which is used to determine the target range. Using this approach, the maximum power of the laser 101 can generally be much lower than methods that use a single laser pulse to detect range.

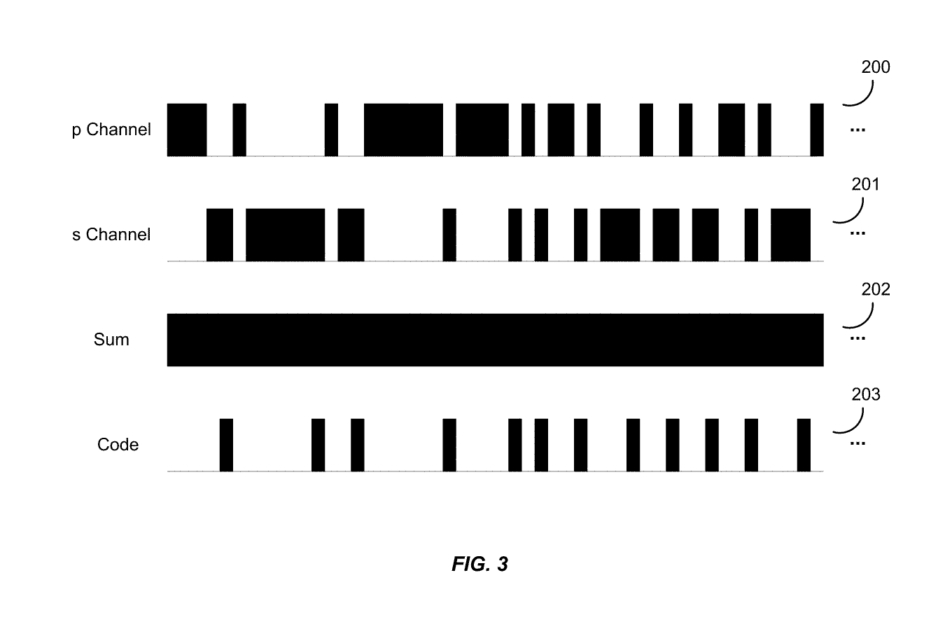

To illustrate, FIG. 3 shows signaling diagrams of polarization switching based on a code. In this embodiment, the CW laser light is configured with orthogonal polarizations “s” and “p”. The p channel (p polarization) of the CW laser light is modulated with a CAL code, in the signaling diagram 200. The s channel (s polarization) of the CW laser light is modulated with the same CAL code in the opposite polarity, as illustrated in the signaling diagram 201. More specifically, the CAL code of the signaling diagram 203 directs the switching between the two polarizations.

For example, a CW laser with a constant polarization state may be used for the laser seed. A high-speed polarization modulator, such as a Pockels cell, modulates the beam between the two polarization states based on the modulating signal that is the CAL code. As the two polarizations are orthogonal, the p channel will be “off” when the s channel is “on”, and vice versa. However, when the two polarizations are summed together, they produce a substantially uniform intensity for the CW laser light, as illustrated in the signaling diagram 202. That is, since the signals of both polarization channels are sourced from a single laser source, the intensity is the sum of both of the s and p channels, which is substantially constant. Accordingly, little to no intensity variations would be observed by a LADAR detection system. That is, the LADAR detection system of the target 104 and/or any other observers (other than the CW LADAR system 100) would simply see the laser light, if anything, without knowing the code sequence was being used to determine a range to the target 104. And, one or both of the s and p channels of the return signal can be correlated with the transmitted signal to determine the time of flight of the CW laser light based on the CAL code sequence.

The polarization modulation scheme of this CAL sensing approach advantageously allows for a substantially uniform intensity laser probe to be used for range measurements. And, the intensity of the laser can be very low because the modulating signal is processed to determine ranges opposed to individual laser pulses of traditional LADAR systems. More specifically, correlation of faster/longer codes (i.e., faster/longer modulations of the polarizations) means that lower intensities of laser light can be used. Accordingly, laser light from the CW LADAR system 100 is much more difficult to detect in the presence of background signals. In fact, the CW LADAR system 100 can even determine range to the target 104 with returns having signal to noise ratios (SNRs) below 1.0.

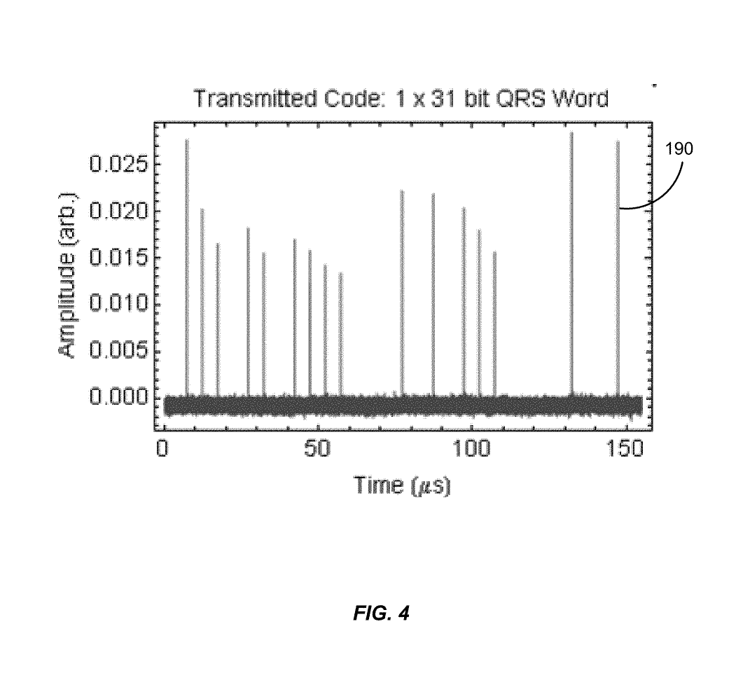

FIGS. 4-7 show experimental results of a LADAR system employing one exemplary CAL technique. In this embodiment, the LADAR system varied the intensity of laser light from a laser to encode the laser light with a 1×31 URS and create “micropulses” (e.g., reference number 190) from the larger “macropulse” sequence of FIG. 4, although the laser light does not have an amplitude of “0”. The micropulses, such as micropulse 190, are created by rapidly switching the amplitude of the laser light. In other words, the encoded laser light varies in amplitude to provide pulse like aspects for detection and ranging purposes while remaining “on” and continuously illuminating a target.

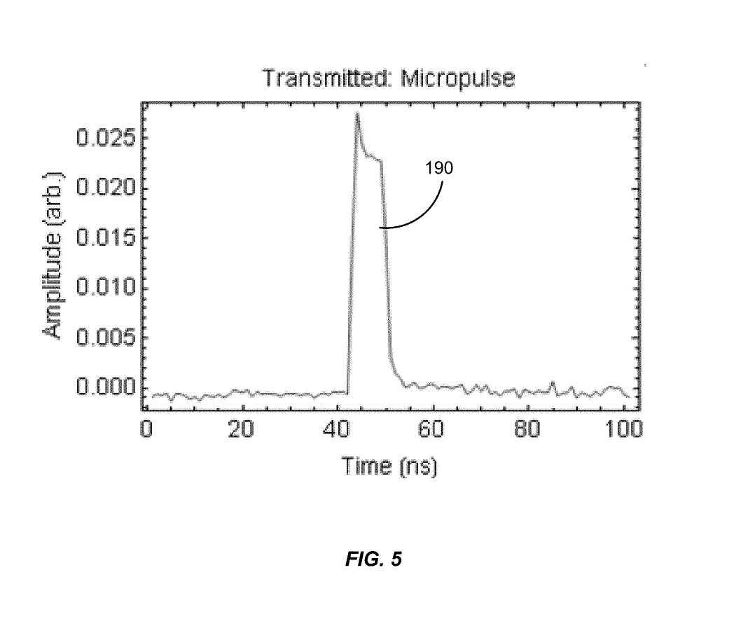

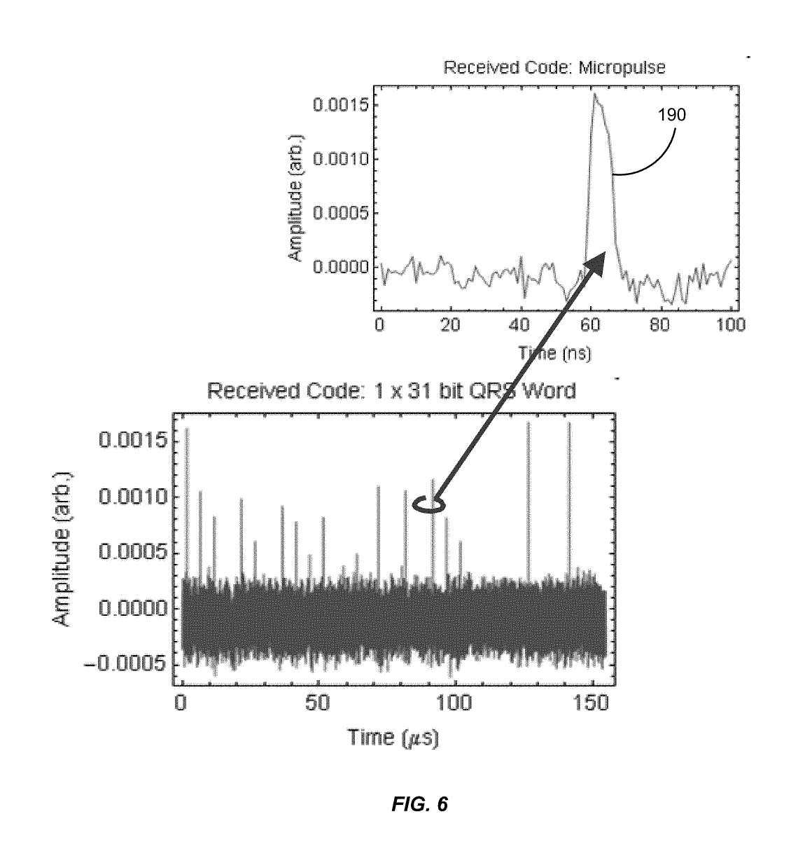

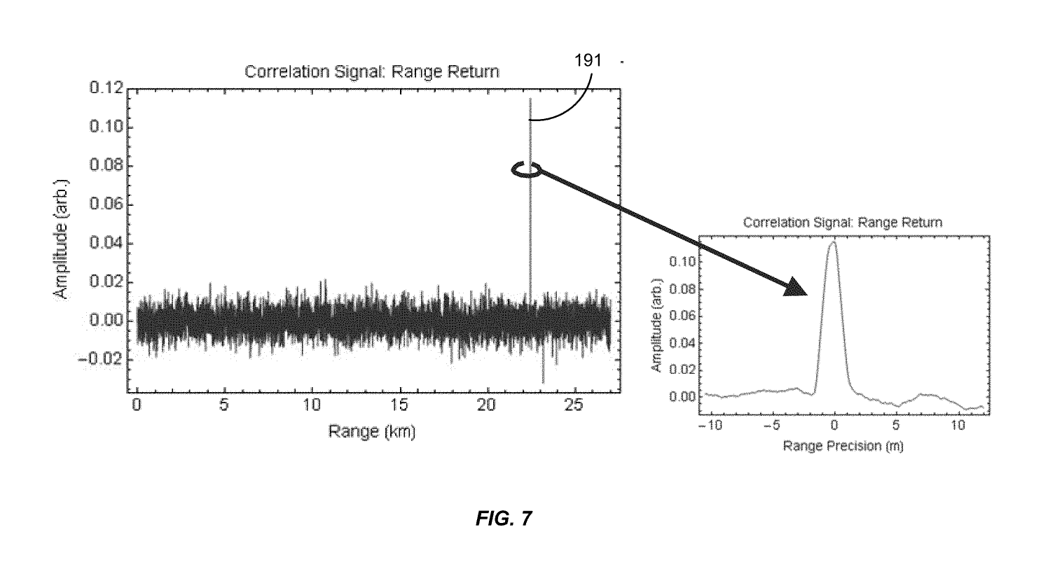

The micropulses, in this embodiment, have substantially fast rise and fall times (e.g., less than 1 ns), as illustrated with the micropulse 190 in FIG. 5. After the pulse sequence is scattered from the target, the received optical signature is digitized and correlated with the initial digital code, as illustrated in FIG. 6. For example, the return signal can be correlated with the transmitted signal. And, as such, the micropulse 190 can be located in the return signal. Once the micropulse 190 is located in the return signal, the range of the target can be determined based on the time of flight of the micropulse 190 as well as the time of flight of the entire macropulse sequence (i.e., to improve range resolution), as illustrated in FIG. 7.

This CAL code correlation method of range determination enables the use of lasers with much lower peak powers than lasers used in traditional pulsed laser methods because the signal used for sensing the range is distributed over a longer time than pulses used in traditional pulsed LADAR systems. That is, the entire CAL code that is returned from the target is correlated with the CAL code being transmitted as opposed to pulsed LADAR systems that produce range ambiguity.

As can be seen in FIG. 7, the CAL code correlation method produces a substantially high correlation peak 191, indicating the range of the target 104 to be approximately 22.5 km with a range precision of approximately +/−2 meters. Accordingly, the CAL approach traverses the constraints of traditional LADAR systems and allows for much faster average pulse repetition rates (i.e., switched polarization states) so that a range acquisition may be made more quickly and more accurately than a traditional LADAR system of similar peak power. This type of CAL correlation can also be achieved via the switched polarizations of the CW LADAR system 100 of FIG. 1. And, the total energy delivered to the target 104 via the CAL code sensing of the CW laser 101 is equal to or larger than traditional LADAR sensing as the sensing occurs over a much longer time.

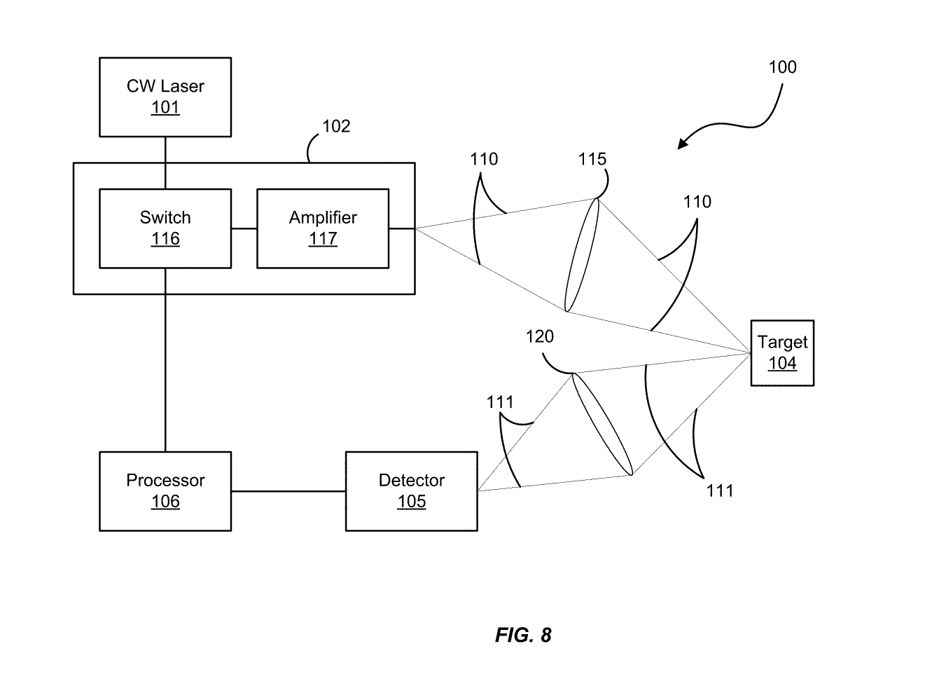

FIG. 8 is a block diagram of another exemplary CW LADAR system 100. In this embodiment, the CW laser 101 is a low-power seed laser, such as a fiber laser or diode laser with a fiber connector. Such lasers are fairly inexpensive and relatively easy to implement. The transmitter 102 comprises a switch 116 and an optical amplifier 117. The switch 116 is a high-speed fiber switch that is coupled to the CW laser 101 to switch the polarizations of the laser light from the CW laser 101 (e.g., with a less than 0.2 nanosecond transition time). The switch 116 is also operable to modulate the polarizations of the laser light with a signal (e.g., a URS code or a pseudorandom sequence). For example, the switch 116 may modulate the CW laser light 101 with a pseudorandom sequence in which there are approximately as many logical “1s” as there are logical “0s” to rapidly switch from one polarization to another according to the modulating signal, thus producing the signaling diagrams 201 and 202 of FIG. 3.

Pseudo random codes (PRCs) may be generated through several methods. One method utilizes quadratic residues of an odd prime number to provide indices to low bits. For example, given the prime number 11, the sequence is generated: 1² mod 11=1, 2² mod 11=4, 3² mod 11=9, 4² mod 11=5, 5² mod 11=3. All positive integers result in a number out of the sequence {1,3,4,5,9}. The PRC is formed by setting the bits corresponding to these integers low, resulting in the following 11-bit binary code: 01000111011. Uniformly redundant sequences (URS) formed in this way have been shown to approach the properties described above for long sequences.

One exemplary procedure for generating a pseudorandom code for computing a cyclic bipolar URS is shown in the following table:

| Psuedo Code | | Description |
|---|---|---|
| N = a prime | | Choose a prime number for the length of the |
| | | code |
| Seq(1:N) = 1; | | Pre-load the sequence with 1's |
| For (count = [1: | | Overwrite (N − 1)/2 sequence elements with −1 |
| (N−1)/2]) | | |
| | Residue = | Element index is remainder of count\hat{ }2/N |

Remainder(count\hat{ }2/N)

Seq(Residue) = −1

End

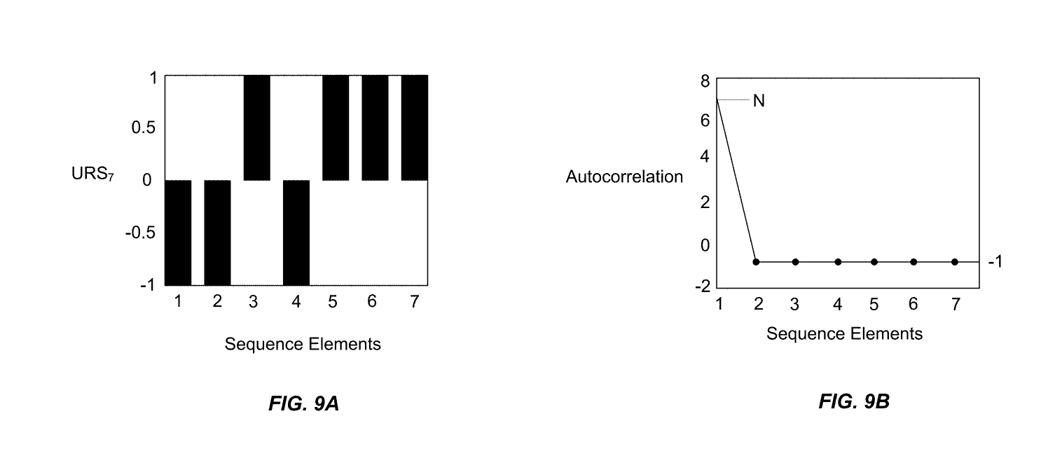

As an example, a bipolar URS of length 7 generated with the above pseudorandom code is illustrated in FIG. 9A. The cyclic autocorrelation of this exemplary code is illustrated in FIG. 9B. Note that the autocorrelation peak is equal to the length of the code and all other elements of the auto-correlation are negative one. The sum of the code is positive one. The amplifier 117, being optically coupled to the switch 102, increases the intensity of the switched polarization CW laser light such that it can be propagated to a beam directing element (e.g., lens or mirror) 115 to direct the laser light onto the target 104 along the beam path 110. After the CW LADAR system 100 illuminates the target 104 along the path 110, the light scattered from the target 104 along the path 111 can be collected by a light collecting element (e.g. lens or focusing reflective element) 120 and detected by the optical detector 105. The optical detector 105 is sensitive to polarization and produces one or more signal channels with sensitivity to the incident laser light polarization.

The detectors 105 may not detect precisely the same two polarizations represented in the code. Instead, the detectors 105 may detect different proportions of the transmitted polarizations. A measurement of the polarization channels may employ processing of the actual detection channels. And, the channels used for correlations may each comprise separate linear combinations of the detected polarizations.

From there, the processor 106 correlates the transmitted signal to the return signal to determine a range of the target 104. While FIG. 8 illustrates a separate beam directing element 115 and light collecting element, in some embodiments a single element may provide both functions.

Various forms of optical amplifiers may be used. For example, the amplifier 117 may be a fiber amplifier that provides enough optical power to reduce the requirements of the CW laser 101 while still providing detectable signal returns.

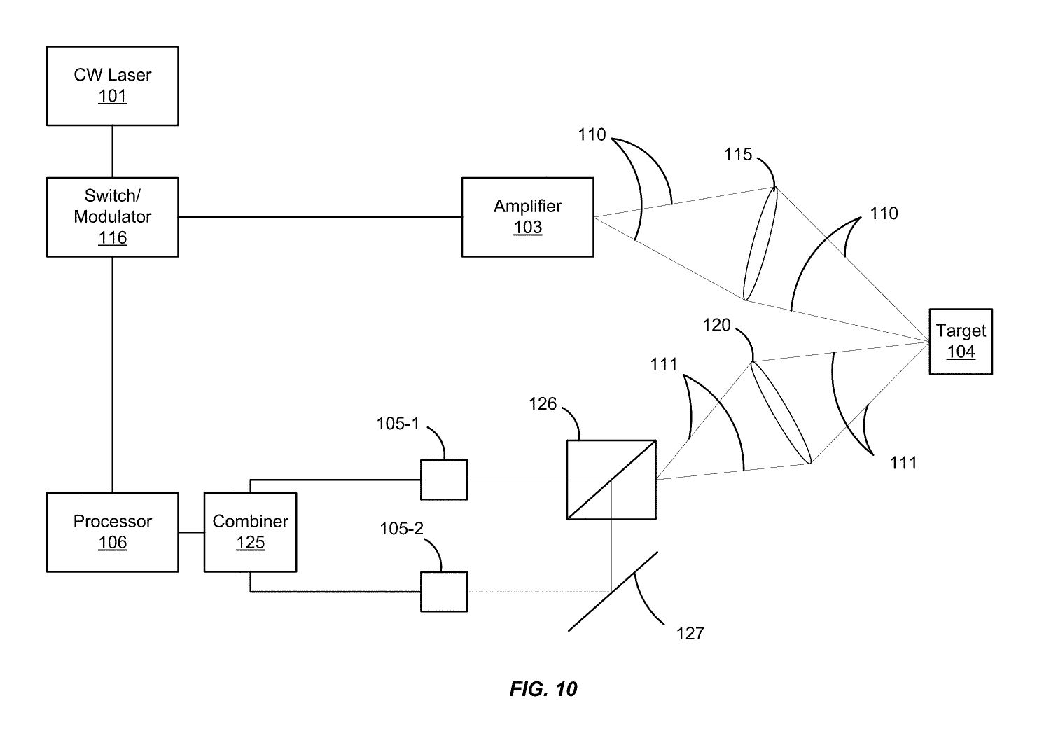

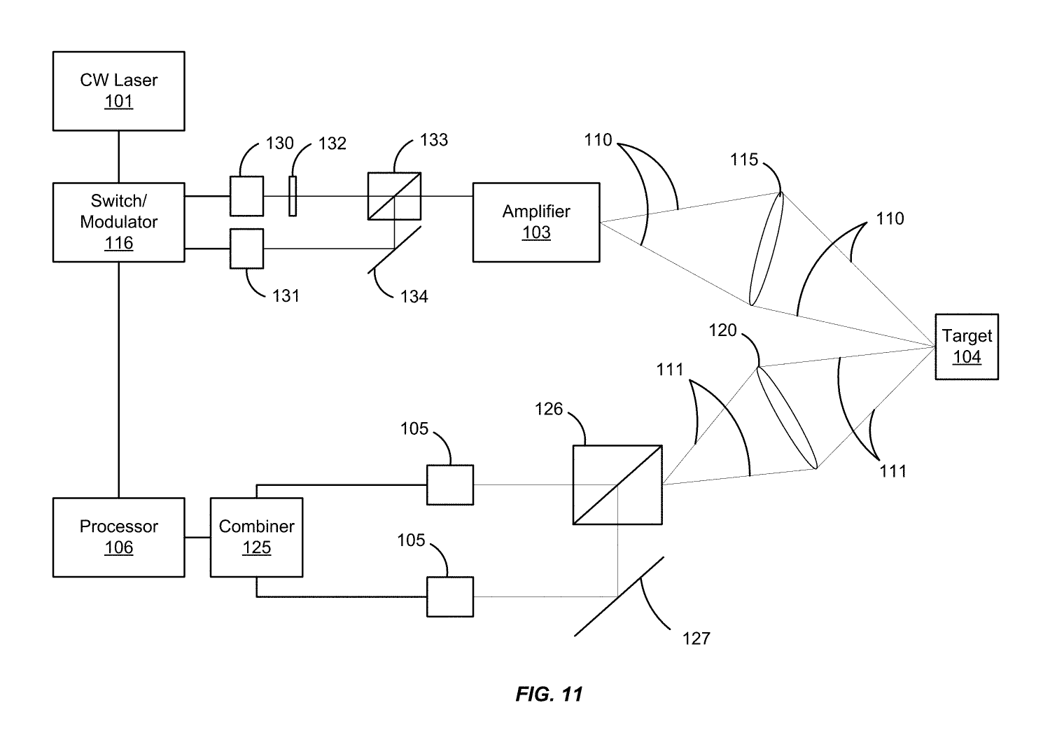

FIG. 10 is a block diagram of another exemplary CW LADAR system 100. In this embodiment, the LADAR system 100 comprises a polarization splitter 126 that receives the scattered CW laser light from the target 104 and splits the polarizations of light into two channels. For example, the polarization splitter 126 may direct the s channel of the CW laser light to the optical detector 105-1. The polarization splitter 126 may direct the p channel of the CW laser light to the optical detector 105-2 via the optical element 127. Again, other polarizations may be used, such as left and right hand circular.

From there, either the s or the p channel can be processed processor 106 for the range determination. And, a combiner 125 combines the two polarizations of the CW laser light such that the processor 106 can process the two polarizations and extract the CAL code, which the processor 106 can then process to determine the range of the target 104. For example, the returned signal may have the polarizations split via the polarization splitter 126. One of the polarizations is directed to the optical detector 105-1 while the other polarization is directed to the optical detector 105-2 via the optical element 127 (e.g., a mirror). The combiner 125 may determine a difference signal from the two received polarizations to extract the CAL code used to modulate between the two polarizations, as illustrated in signaling diagram 203 of FIG. 3. The CAL code can then be processed by correlating it with the transmitted CAL code to determine a range to the target 104. The optical elements 126 and/or 127 may also employ a spectral filter to remove background light from the receiver. Of course, spectral filtering may be performed by other components of the receiver.

Generally, the receiver may consist of multiple detectors 105 having different polarization sensitivities. The sensitivities may not be matched to the transmitted polarizations, however processing of the detector signals may be used to extract the transmitted polarizations. For example, suppose the signal from detector 105-1 is S₁=χ₁(0.9 P₁+0.1 P₂) where P1 is the optical power received at a first polarization S1, P2 is the optical power received at the second polarization, and χ1 is the detector response. Likewise, suppose that S₂=χ₂ (0.1 P₁+0.9 P₂) is the signal from detector 105-2 having response χ2. A new signal could then be defined as S̅₁=χ₁P₁ which equals

$$1.125 {S}_{1} - 0.125 ( \frac{{χ}_{1}}{{χ}_{2}} ) {S}_{2}$$

and, S̅₂=χ₂P₂ which equals

$$1.125 {S}_{2} - 0.125 ( \frac{{χ}_{2}}{{χ}_{1}} ) {S}_{1} .$$

These newly defined signals could be used for subsequent processing. In this example, more conversions may be employed depending on the details of the detection methodology. And, if more than two polarizations are used, the signals would be categorized as a specific polarization prior to correlations.

FIG. 11 is a block diagram of another exemplary CW LADAR system 100. In this embodiment, the CW laser 101 is a seed laser having a constant polarization state. The switch/modulator 116 is a high speed fiber switch having first and second output ports 130 and 131 that collimate the beams. The switch 116 is electronically modulated to rout the laser signal through either the output port 130 or the output port 131 based on the modulating signal. In this regard, the signal from the output port 130 has its polarization modified to be in an orthogonal state to the polarization of the signal exiting the output port 131, for example, through the use of a λ/2 waveplate 132. The signal exiting the output port 131 is spatially combined with the polarization modified signal from the output port 130 with a polarization beam combiner 133 and the assistance of the optical element 134 (e.g., a mirror).

The polarization beam combiner 133 may be a thin film polarizer or a prism-based polarization beam combiner, such as Glan-Thompson beam splitter. The combined signal may be passed through a fiber amplifier 103 that amplifies both polarizations for illumination of the target 104. From there, the CW laser light is scattered from the target 104 and received/processed as shown and described above.

Alternatively, the transmitter 101 may comprise a two or more lasers such that the switch/modulator 116 separately modulates the beams. For example, each laser may comprise a single polarization, each being different. The switch/modulator 116 may separately modulate the beams with CAL code sequence. Thus, the laser beam output from the output port 103 may have the CAL code sequence in one polarity and the laser beam output from the output port 131 may have the same or similar CAL code sequence in the opposite polarity. The switch/modulator, in this regard, may synchronize the modulation between the beams. From there, the beams may be combined via the combiner 133 and propagated to the target 104. And, detection and ranging of the target 104 can then be determined by processing the sequence of the polarizations (s and p polarizations or left and right hand circular polarizations).

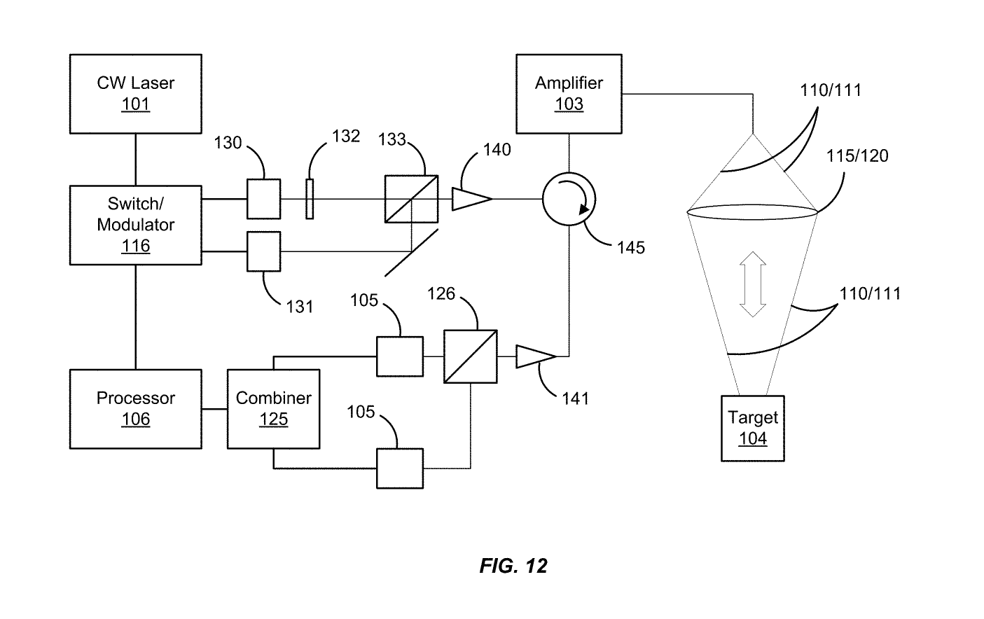

The exemplary embodiments of FIGS. 8, and 10-11 illustrate separate transmitters and receivers. However, for many situations, it is desirable for the transmitter and receiver to share a common aperture. For example, if scanning optics are used, higher efficiency coupling of the received signal with less exposure to background signals (e.g., interference) may be possible if the scanning optics are shared by the transmitter and receiver through a common pupil or fiber aperture. FIG. 12 is a block diagram of another exemplary CW LADAR system 100 in which both the receiver and transmitter share such common optics (e.g., beam directing element 115/light collecting element 120).

Additionally or alternatively, the amplifier 103 may be shared by both the transmitter and the receiver. For example, a fiber optical circulator 145 may be used to isolate the received signal from the transmitted signal with minimal contamination of the received signal by the transmitted signal. That is, the fiber optical circulator 145 allows the transmitted beam to pass to the amplifier 103 while allowing the beam scattered from the target 104 to pass from the amplifier 103 without interfering with one another. The light scattered from the target 104 passes from the optical circulator 145 to the input port 141 of the receiver portion of the LADAR system 100, where the return signal of the CW laser light is correlated with the transmitted signal by the processor 106 to determine the range of the target 104.

The common optical amplifier 103, in this embodiment, is again a fiber amplifier that amplifies both the transmitted and received signals. It should be noted that the fiber optical circulator 145 may be used whether a shared amplifier 103 is used or not. Additionally, an optical amplifier may be configured to operate only on the transmitted signal, as illustrated in FIGS. 8, 10, and 11, while still utilizing the fiber optical circulator 145 (or other transceiver architectures, such as a hole mirror, beam splitter, etc.) to enable a monostatic LADAR configuration.

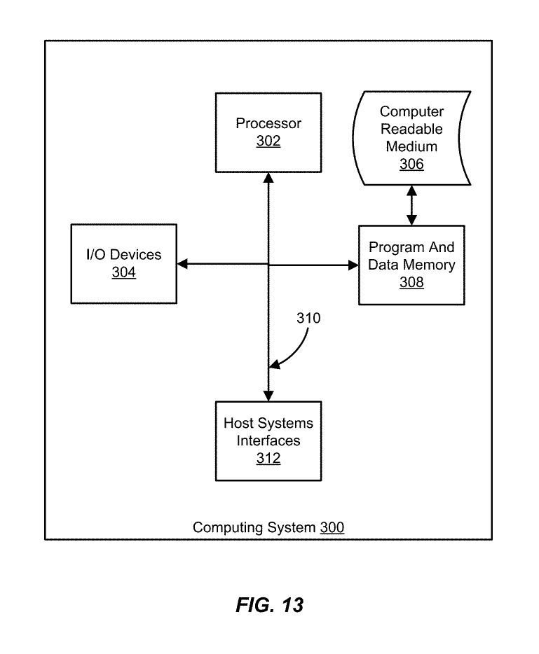

Any of the above embodiments herein may be rearranged and/or combined with other embodiments. Accordingly, the invention is not to be limited to any particular embodiment disclosed herein. Additionally, the invention can also take the form of an entirely hardware embodiment or an embodiment containing both hardware and software elements. In one embodiment, portions of the invention are implemented in software (e.g., the processing by the processor 106 and/or the modulation by the transmitter 102), which includes but is not limited to firmware, resident software, microcode, etc. FIG. 13 illustrates a computing system 300 in which a computer readable medium 306 may provide instructions for performing any of the methods disclosed herein.

Furthermore, the invention can take the form of a computer program product accessible from the computer readable medium 306 providing program code for use by or in connection with a computer or any instruction execution system. For the purposes of this description, the computer readable medium 306 can be any apparatus that can tangibly store the program for use by or in connection with the instruction execution system, apparatus, or device, including the computer system 300.

The medium 306 can be any tangible electronic, magnetic, optical, electromagnetic, infrared, or semiconductor system (or apparatus or device). Examples of a computer readable medium 306 include a semiconductor or solid state memory, magnetic tape, a removable computer diskette, a random access memory (RAM), a read-only memory (ROM), a rigid magnetic disk and an optical disk. Some examples of optical disks include compact disk-read only memory (CD-ROM), compact disk-read/write (CD-R/W) and DVD.

The computing system 300, suitable for storing and/or executing program code, can include one or more processors 302 coupled directly or indirectly to memory 308 through a system bus 310. The memory 308 can include local memory employed during actual execution of the program code, bulk storage, and cache memories which provide temporary storage of at least some program code in order to reduce the number of times code is retrieved from bulk storage during execution. Input/output or I/O devices 304 (including but not limited to keyboards, displays, pointing devices, etc.) can be coupled to the system either directly or through intervening I/O controllers. Network adapters may also be coupled to the system to enable the computing system 300 to become coupled to other data processing systems, such as through host systems interfaces 312, or remote printers or storage devices through intervening private or public networks. Modems, cable modem and Ethernet cards are just a few of the currently available types of network adapters.

1. A laser detection and ranging (LADAR) system, comprising:
a transmitter operable to switch continuous wave (CW) laser light between two or more polarizations based on a code, and to transmit the two or more polarizations of the CW laser light at a target;
a receiver operable to detect the two or more polarizations of the CW laser light reflected from the target; and
a processor operable to determine a range of the target based on a time of flight of the switched polarizations of the CW laser light from the transmitter to the receiver according to the code.

2. The LADAR system of claim 1, wherein:
the transmitter comprises a phase plate operable to operable to switch between the two or more polarizations.

3. The LADAR system of claim 1, wherein:
the processor is further operable to determine the range of the target by correlating a return of the code with a transmission of the code.

4. The LADAR system of claim 1, wherein:
a sum of intensities of first and second of the two or more polarizations of the CW laser light is substantially uniform.

5. The LADAR system of claim 1, wherein:
the code comprises a pseudorandom sequence.

6. The LADAR system of claim 1, wherein:
the code comprises a uniformly redundant sequence.

7. The LADAR system of claim 1, wherein:
the code comprises a cyclic Coded Aperture LADAR code sequence.

8. The LADAR system of claim 1, wherein:
the processor is further operable to determine a difference between a first of the two or more polarizations and a second of the two or more polarizations, and to determine the code from the difference, and to determine the range of the target by correlating a return of the code with a transmission of the code.

9. The LADAR system of claim 1, wherein:
a first and a second of the two or more polarizations of the CW laser light are orthogonal.

10. The LADAR system of claim 1, wherein:
a first of the two or more polarizations of the CW laser light is a left circular polarization and a second of the two or more polarization of the CW laser light is a right circular polarization

11. The LADAR system of claim 1, wherein:
the transmitter comprises an optical switch having a first output port for a first of the two or more polarizations of the CW laser light and a second output port for a second of the two or more polarizations of the CW laser light; and
the LADAR system further comprises a polarization combining element to combine the first and second polarizations of the CW laser light.

12. The LADAR system of claim 1, wherein:
the CW laser light is diffusely scattered, specularly scattered, or scattered as a combination thereof by the target prior to being received by receiver.

13. The LADAR system of claim 1, wherein:
the receiver includes a polarization splitting element and first and second optical detectors;
the first optical detector is operable to detect a first of the two or more polarizations of the CW laser light; and
the second optical detector is operable to detect a second of the two or more polarizations of the CW laser light.

14. The LADAR system of claim 1, wherein:
the processor is further operable to correlate a return of the code with a transmission of the code from the first polarization, the second polarization, or both.

15. The LADAR system of claim 1, wherein:
the receiver and the transmitter share a common aperture.

16. The LADAR system of claim 1, wherein:
the receiver and transmitter share a common optical amplifier.

17. The LADAR system of claim 1, further comprising:
scanning optics operable to angularly direct the transmitted two or more polarizations of the CW laser light to the target.

18. The LADAR system of claim 1, further comprising:
scanning optics operable to angularly direct the receiver.

19. The LADAR system of claim 1, further comprising:
an amplifier operable to increase intensity of the CW laser light.

20. The LADAR system of claim 19, wherein:
the amplifier is a fiber amplifier.

21. The LADAR system of claim 1, wherein:
the receiver additionally includes a spectral filter to remove background light from the receiver.

22. A Laser Detection and Ranging (LADAR) method, comprising:
switching continuous wave (CW) laser light between the two or more polarizations based on a code;
transmitting the two or more polarizations of the CW laser light at a target;
detecting the two or more polarizations of the CW laser light reflected from the target; and
determining a range of the target based on a time of flight of the switched polarizations of the CW laser light from the transmitter to the receiver according to the code.

23. A non-transitory computer readable medium comprising instructions that, when executed by a processor of a Laser Detection and Ranging (LADAR) system, direct the processor to:
switch continuous wave (CW) laser light from a laser between the two or more polarizations based on a code;
transmit the two or more polarizations of the CW laser light from the laser at a target;
detect the two or more polarizations of the CW laser light reflected from the target; and
determine a range of the target based on a time of flight of the switched polarizations of the CW laser light from the transmitter to the receiver according to the code.
